(19) United States
(12) Patent Application Publication
(10) Pub. No.: US 2026/0299754 A1
(43) Pub. Date: Oct. 1, 2026

(54) OBJECT MANAGEMENT METHOD, ELECTRONIC DEVICE, AND STORAGE MEDIUM

(71) Applicant: Beijing Youzhuju Network Technology Co., Ltd., Pinggu District, Beijing (CN)

(72) Inventors: Zhixin SHEN, Beijing (CN); Guorong ZHU, Beijing (CN); Enze LI, Beijing (CN); Simin LIU, Beijing (CN); Hongtao HU, Beijing (CN); Jin CAI, Beijing (CN); Siliu ZHANG, Beijing (CN); Zuochi WEN, Beijing (CN); Yu WANG, Beijing (CN); Diling YUAN, Beijing (CN); Can XIAO, Beijing (CN)

(21) Appl. No.: 19/480,292

(22) PCT Filed: Oct. 22, 2024
(86) PCT No.: PCT/CN2024/126406

§ 371 Date: Oct. 30, 2025

(30) Foreign Application Priority Data
Jan. 31, 2024 (CN) 202410139333.6

(51) Int. Cl. G06F 3/0482; G06F 3/04842

(52) U.S. Cl. CPC G06F 3/0482; G06F 3/04842

(57) ABSTRACT

An object management method, an electronic device and a storage medium are provided. The method includes: obtaining, in response to creating a first object combination on a management page of a target entity, at least two parent objects included in the first object combination, where the at least two parent objects belong to the target entity; obtaining a target child object corresponding to each of the at least two parent objects from sub-entities of the target entity, where attribute information of the target child object is the same as attribute information of the corresponding parent object; and displaying, for a first sub-entity including at least two target child objects among the sub-entities of the target entity, a second object combination on a management page of the first sub-entity, where the second object combination includes the at least two target child objects.

The present application claims priority to Chinese Patent Application No. 202410139333.6, filed on Jan. 31, 2024, which is incorporated herein by reference in its entirety as a part of the present application.

### TECHNICAL FIELD

The present disclosure relates to an object management method and apparatus, an electronic device, and a readable medium.

### BACKGROUND

Instant retail is a highly time-sensitive home-delivery consumption model based on an instant delivery system, and belongs to common emerging retail and consumption models. Its main features are that consumers place orders on online transaction platforms, and offline physical retailers receive the orders, and then pick, pack, and deliver goods to addresses specified by the customers, with the orders completed within approximately 30 to 60 minutes.

With the development of instant retail, many chain entities (e.g., chain merchants) have joined online transaction platforms for instant retail. A chain entity typically has numerous sub-entities (e.g., stores), and parent objects of the headquarters of the chain entity correspond to different child objects across different sub-entities. Therefore, there is an urgent need to provide staff of chain enterprises with a technical solution of managing child objects across numerous sub-entities, to enable faster and more convenient management of child objects across numerous sub-entities included in a target entity.

### SUMMARY

The present disclosure provides an object management method. The method includes:
obtaining, in response to creating a first object combination on a management page of a target entity, at least two parent objects included in the first object combination, where the at least two parent objects belong to the target entity;
obtaining a target child object corresponding to each of the at least two parent objects from sub-entities of the target entity, where attribute information of the target child object is the same as attribute information of the corresponding parent object; and
displaying, for a first sub-entity including at least two target child objects among the sub-entities of the target entity, a second object combination on a management page of the first sub-entity, where the second object combination includes the at least two target child objects.

In a possible implementation, a third object combination of the target entity includes a first parent object and a second parent object, a second sub-entity of the target entity includes only a first target child object corresponding to the first parent object, and the method further includes:
associating, in response to setting a second target child object corresponding to the second parent object in the second sub-entity to a first state and performing a synchronization operation on the third object combination, the third object combination on a management page of the second sub-entity to obtain a fourth object combination, and displaying the fourth object combination on a display page of the second sub-entity, where the fourth object combination includes the first target child object and the second target child object, and a child object in the first state is a child object used to be displayed on the display page of the second sub-entity.

In a possible implementation, the method further includes:
displaying, in response to updating the first object combination on the management page of the target entity, an updated second object combination on the management page of the first sub-entity, where the updated second object combination corresponds to the updating for the first object combination;
modifying the first state of the second object combination into a second state on the management page of the first sub-entity in response to performing a first operation on the first object combination on the management page of the target entity, where an object combination in the second state is an object combination used to be hidden or deleted from a display page of the first sub-entity; and
deleting the second object combination from the management page of the first sub-entity in response to deleting the first object combination from the management page of the target entity.

In a possible implementation, the method further includes:
displaying the second object combination on a display page of the first sub-entity in response to performing a synchronization operation on the first object combination on the management page of the target entity;
or
displaying the second object combination on a display page of the first sub-entity in response to performing a second operation on the second object combination on the management page of the first sub-entity.

In a possible implementation, the method further includes:
obtaining, in response to creating a shared content component to be displayed on the management page of the target entity and selecting a set of parent objects to be displayed, a set of child objects corresponding to the set of parent objects from the sub-entities of the target entity, where the set of parent objects includes at least one parent object, and the child objects included in the set of child objects are in a one-to-one correspondence with the parent objects included in the set of parent objects; and
displaying the shared content component in each child object included in the set of child objects for each of the sub-entities of the target entity.

In a possible implementation, the displaying the shared content component in each child object included in the set of child objects for each of the sub-entities of the target entity, includes:
displaying, in response to the shared content component being configured with a display time, the shared content component in each child object included in the set of child objects for each of the sub-entities of the target entity based on the display time.

In a possible implementation, the method further includes:
obtaining, in response to an upload operation of a material image for a third parent object on a material image management tool of the target entity, a first material image of the third parent object, where the material image management tool is used to display a material image upload status of each parent object in the target entity; and
in response to the first material image being approved, applying the first material image in a child object corresponding to the third parent object for each of the sub-entities of the target entity.

The present disclosure further provides an object management apparatus. The apparatus includes: a first obtaining unit, a second obtaining unit and a first display unit.

The first obtaining unit is configured to obtain, in response to creating a first object combination on a management page of a target entity, at least two parent objects included in the first object combination, where the at least two parent objects belong to the target entity.

The second obtaining unit is configured to obtain a target child object corresponding to each of the at least two parent objects from sub-entities of the target entity, where attribute information of the target child object is the same as attribute information of the corresponding parent object.

The first display unit is configured to display, for a first sub-entity including at least two target child objects among the sub-entities of the target entity, a second object combination on a management page of the first sub-entity, where the second object combination includes the at least two target child objects.

In a possible implementation, a third object combination of the target entity includes a first parent object and a second parent object, a second sub-entity of the target entity includes only a first target child object corresponding to the first parent object, and the apparatus further includes an association display unit.

The association display unit is configured to: associate, in response to setting a second target child object corresponding to the second parent object in the second sub-entity to a first state and performing a synchronization operation on the third object combination, the third object combination on a management page of the second sub-entity to obtain a fourth object combination, and display the fourth object combination on a display page of the second sub-entity, where the fourth object combination includes the first target child object and the second target child object, and a child object in the first state is a child object used to be displayed on the display page of the second sub-entity.

In a possible implementation, the apparatus further includes an update unit and a deletion unit.

The update unit is configured to: display, in response to updating the first object combination on the management page of the target entity, an updated second object combination on the management page of the first sub-entity, where the updated second object combination corresponds to the updating for the first object combination; and
modify the first state of the second object combination into a second state on the management page of the first sub-entity in response to performing a first operation on the first object combination on the management page of the target entity, where an object combination in the second state is an object combination used to be hidden or deleted from a display page of the first sub-entity.

The deletion unit is configured to delete the second object combination from the management page of the first sub-entity in response to deleting the first object combination from the management page of the target entity.

In a possible implementation, the apparatus further includes a second display unit.

The second display unit is configured to display the second object combination on a display page of the first sub-entity in response to performing a synchronization operation on the first object combination on the management page of the target entity.

Or, the second display unit is configured to display the second object combination on a display page of the first sub-entity in response to performing a second operation on the second object combination on the management page of the first sub-entity.

In a possible implementation, the apparatus further includes: a third obtaining unit and a third display unit.

The third obtaining unit is configured to: obtain, in response to creating a shared content component to be displayed on the management page of the target entity and selecting a set of parent objects to be displayed, a set of child objects corresponding to the set of parent objects from the sub-entities of the target entity, where the set of parent objects includes at least one parent object, and the child objects included in the set of child objects are in a one-to-one correspondence with the parent objects included in the set of parent objects.

The third display unit is configured to display the shared content component in each child object included in the set of child objects for each of the sub-entities of the target entity.

In a possible implementation, the third display unit is specifically configured to:

display, in response to the shared content component being configured with a display time, the shared content component in each child object included in the set of child objects for each of the sub-entities of the target entity based on the display time.

In a possible implementation, the apparatus further includes: a fourth obtaining unit and a fourth display unit.

The fourth obtaining unit is configured to obtain, in response to an upload operation of a material image for a third parent object on a material image management tool of the target entity, a first material image of the third parent object, where the material image management tool is used to display a material image upload status of each parent object in the target entity.

The fourth display unit is configured to apply, in response to the first material image being approved, the first material image in a child object corresponding to the third parent object for each of the sub-entities of the target entity.

It should be noted that, for a specific implementation of the apparatus and an achieved technical effect, reference may be made to the relevant description of the method according to any one of the implementations described above.

The present disclosure further provides an electronic device. The electronic device includes: a processor and a memory, where the memory is configured to store instructions or a program; and

the processor is configured to execute the instructions or the program in the memory, to cause the electronic device to perform the method according to any one of the implementations described above.

The present disclosure further provides a readable medium storing instructions or a program that, when run on a processor, causes the processor to perform the method the method according to any one of the implementations described above.

### BRIEF DESCRIPTION OF DRAWINGS

To describe the technical solutions in the embodiments of the present disclosure more clearly, the accompanying drawings for describing the embodiments are briefly described below. Apparently, the accompanying drawings in the following description are merely some embodiments recited in the present disclosure, and persons of ordinary skill in the art may still derive other accompanying drawings from these accompanying drawings without creative efforts.

FIG. 1 is a schematic flowchart of an object management method according to an embodiment of the present disclosure;

FIG. 2 is a schematic diagram of inheritance from an object combination of parent objects to sub-entities according to an embodiment of the present disclosure;

FIG. 3 is a schematic diagram of batch application of shared content components according to an embodiment of the present disclosure;

FIG. 4 is a schematic diagram of batch application of uploading a white background image according to an embodiment of the present disclosure;

FIG. 5 is a schematic structural diagram of an object management apparatus 500 according to an embodiment of the present disclosure; and

FIG. 6 is a schematic structural diagram of an electronic device 600 according to an embodiment of the present disclosure.

### DETAILED DESCRIPTION

With the development of instant retail, many chain entities have joined online transaction platforms. The chain entities may be, for example, supermarket enterprises, pharmaceutical enterprises, or clothing enterprises. A chain entity has a plurality of sub-entities. For example, a supermarket enterprise A has a store a1, a store a2, and a store a3. An online transaction platform may refer to an e-commerce transaction platform that can be accessed by consumers to purchase products or services. On the online transaction platform, consumers can view and purchase objects for sale in sub-entities of the chain entity. For example, when a supermarket A joins an online transaction platform B, and the supermarket enterprise A has a store a1, a store a2, and a store a3, consumers can view and purchase products for sale in the store a1, the store a2, or the store a3 through the online transaction platform B.

For a chain entity, the chain entity may include at least the headquarters and stores. Optionally, the chain entity may further include managed unit stores, which are used to manage some stores. The management authority of the managed unit stores is controlled by the headquarters, and the authority of the stores is controlled by both the headquarters and the managed unit store, with the headquarters having a higher priority in control. For example, the supermarket enterprise A includes the headquarters 1, a managed unit store 1, a managed unit store 2, a store 1, a store 2, a store 3, a store 4, and a store 5. The store 1 and the store 5 are both managed by the headquarters 1 and the managed unit store 1, and the store 2, the store 3, and the store 4 are managed by the headquarters 1 and the managed unit store 2. In the embodiments of the present disclosure, an entity may refer to a headquarters or a managed unit store of a chain enterprise, and a sub-entity may refer to a store of the chain enterprise.

In a chain entity, an object included in the entity is denoted as a parent object, and an object in a sub-entity is denoted as a child object. One child object corresponds to one parent object in the entity. The corresponding parent object and child object have the same attribute information, except that: the parent object in the entity does not need to be displayed and sold to consumers and therefore may not have the attributes of price and inventory, while the child object needs to be displayed and sold to consumers and therefore needs to include price and inventory in addition to the attribute information (such as a product name, a product image, product shelf life, etc.) included in the parent object. Assuming that attribute information of a parent object 1 in an entity A is attribute information 1, attribute information of a child object 1 corresponding to the parent object 1 in a child object a of the entity A may include: attribute information 1, price=x, and inventory=y.

It should be noted that the parent object in the entity may have a corresponding child object in each sub-entity or may have corresponding child objects in a part of sub-entities. The child objects included in the sub-entity may fully correspond to the parent objects included in the entity, or the child objects included in the sub-entity may partially correspond to the parent objects included in the entity. For example, if the headquarters of the supermarket enterprise A has a parent product 1, a parent product 2 and a parent product 3, and the supermarket enterprise A includes a store 1, a store 2 and a store 3, where the parent product 1 is distributed to the store 1, the store 2 and the store 3, such that the store 1 has a child product 11, the store 2 has a child product 21, and the store 3 has a child product 31; the parent product 2 is distributed to the store 2 and the store 3, such that the store 2 has a child product 22, and the store 3 has a child product 32; and the parent product 3 is distributed to the store 1 and the store 2, such that the store 1 has a child product 13, and the store 2 has a child product 23. In this way, the parent product 1 has a corresponding child object in each store, and the parent product 2 and the parent product 3 have corresponding child products only in a part of the stores. Only the child objects in the store 2 fully correspond to the parent objects of the headquarters of the supermarket enterprise A, with all three are present, and the child objects in the other two stores only partially correspond to the parent objects of the headquarters of the supermarket enterprise A.

In the instant retail scenario, more and more large-scale chain entities (i.e., including numerous sub-entities) are joining online transaction platforms. Currently, the management of child objects in sub-entities require manual one-by-one operations by staff of chain entities, which is not only inefficient but also prone to omissions or errors, making it unfriendly for chain enterprise.

Based on this, the embodiments of the present disclosure provide an object management method. A function of creating an object combination of parent objects is provided on a management page of a target entity, and when a first object combination is created in the target entity through the function, a user can view a second object combination inherited from the first object combination on a management page of a target sub-entity belonging to the target entity. In a specific implementation, the method may include: obtaining, in response to creating a first object combination on a management page of a target entity, at least two parent objects included in the first object combination, where the at least two parent objects belong to the target entity; obtaining a target child object corresponding to each of the at least two parent objects from sub-entities of the target entity, where attribute information of the target child object is the same as that of the corresponding parent object; and displaying for a first sub-entity including at least two target child objects among the sub-entities of the target entity, a second object combination on a management page of the first sub-entity, where the second object combination includes the at least two target child objects.

In this way, through the method, an object combination of parent objects created in a chain entity can be automatically inherited by each sub-entity of the chain entity, and an object combination of child objects corresponding to the object combination of parent objects created by the chain entity can be automatically obtained on a management page of each sub-entity. This eliminates the need for staff to manually configure corresponding object combinations of child objects one by one across numerous sub-entities of a chain enterprise based on the object combination of parent objects, thereby significantly reducing labor, resources and time costs, improving the efficiency of managing the child objects included in the sub-entities of the chain entity, and enabling more intelligent management of the chain entity in the instant retail scenario.

In addition, in the embodiments of the present disclosure, object management tools with other functions are also provided, and all these object management tools can perform batch processing of corresponding functions for objects in the chain entity. A tool for the object combination inheritance function described above may be understood as a batch matching tool. Other object management tools, for example, may include but are not limited to: a tool for batch synchronization of shared content components or a tool for batch uploading of material images.

It should be noted that an entity implementing the object management method may be an object management apparatus according to the embodiments of the present disclosure. The object management apparatus may be carried in an electronic device or a functional module of an electronic device. The object management apparatus may be, for example, a functional module on a work website provided by an online consumption platform for use by staff of the chain entity or on a server corresponding to the work website, configured to perform object management functions provided in the embodiments of the present disclosure

It should be noted that, in the embodiments of the present disclosure, listing may be understood as setting a parent object or child object to a first state, where the child object in the first state can be displayed to consumers through a display page of a sub-entity to which the child object belongs. Delisting may be understood as setting a parent object or child object to a second state, where the child object in the second state is not displayed on a display page of a sub-entity to which the child object belongs or is hidden or deleted.

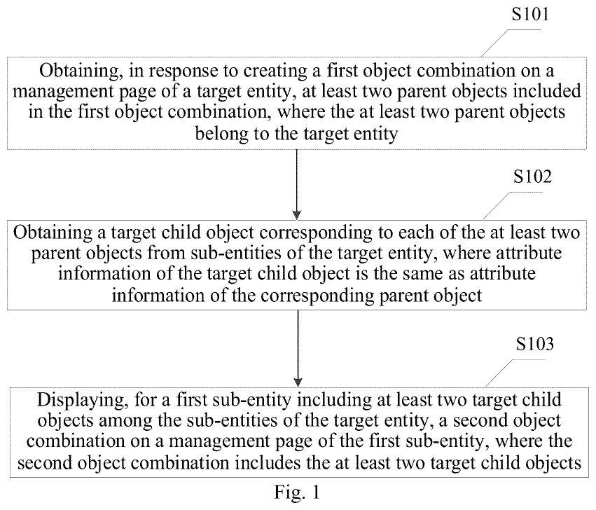

FIG. 1 is a schematic flowchart of an object management method according to an embodiment of the present disclosure. The method may be applied to an object management apparatus, and the object management apparatus may be, for example, the object management apparatus 500 shown in FIG. 5 below.

As shown in FIG. 1, the method may include, for example, S101 to S103.

S101: obtaining, in response to creating a first object combination on a management page of a target entity, at least two parent objects included in the first object combination, where the at least two parent objects belong to the target entity.

The target entity may refer to the headquarters or any level of managed unit store of any chain enterprise that has joined an online consumption platform in the instant retail scenario. Staff of the target entity may log in to a work website provided by the consumer platform for the staff of the target entity in manners such as account-password or account-verification code, to implement management and configuration for the target entity through operations on management pages of the work website. The management and configuration for the target entity include the process of “creating” the first object combination mentioned in S101. Since a store of the chain enterprise does not have permission to independently create an object combination, the target entity cannot be a store. If a managed unit store of the chain enterprise has permission to independently publish products, it may be considered that the managed unit store has permission to create an object combination. Therefore, the target entity may also be a managed unit store. However, once the managed unit store no longer has permission to independently publish products, parent objects in the managed unit store are delisted, and then the object combinations created by the managed unit store are also delisted.

The first object combination may refer to any combination obtained by matching parent objects included in the target entity, and the first object combination may include at least two parent objects in the target entity. For example, when the target entity is a supermarket enterprise A and the supermarket enterprise A includes parent products A1, A2, . . . , and A100, the first object combination may be a combination formed by matching at least two of A1, A2, . . . , and A100. For example, the first object combination may be A1+A3+A100. For another example, the first object combination may be A2+A30. For yet another example, the first object combination may be A5+A33+A89+A100.

A user may manually or automatically create the first object combination on the management page of the target entity.

As an example, the management page of the target entity includes an operation option corresponding to an automatic matching function. By performing an action on the operation option, the staff may trigger the backend of the management page to automatically match objects for the target entity, to generate at least one first object combination. In this way, the staff of the target entity only needs to perform a one-click operation on the management page, such that the management page may automatically generate the first object combination for the target entity, thereby facilitating the staff of the target entity.

For example, in parent objects of a target entity, if a main image of a certain parent object or a detail image of the parent object includes another parent object in the target entity, a functional module implementing the automatic matching function on the management page may perform parent object matching based on the image including at least two parent objects. In this example, the process of creating the first object combination may, for example, include: determining a matching main image from images of the parent objects included in the target entity, where the matching main image includes at least two parent objects; and determining at least two parent objects in the matching main image as a first object combination. The first object combination generated in this example may be referred to as an object combination “with a main image”. The first object combination may include the matching main image, object identifiers of each parent object in the matching main image, anchor points corresponding to each parent object in the matching main image, and a first matching identifier. In this example, the core of the functional module implementing the automatic matching function is an image recognition algorithm. The principle of the image recognition algorithm may be understood as follows: searching the parent objects of the target entity for the matching main image, searching the matching main image for another parent object included in the matching main image, marking the found parent object in the matching main image, and placing an anchor point at a corresponding location.

For another example, in parent objects of a target entity, if a main image of a certain parent object or a detail image of the parent object does not include another parent object in the target entity, the functional module implementing the automatic matching function on the management page may perform parent object matching based on an association algorithm. In this example, the process of creating the first object combination may, for example, include: classifying the parent objects included in the target entity into different categories; combining the parent objects belonging to a first category and the parent objects belonging to a second category, to obtain candidate object combinations, where the first category and the second category have a preset category mapping relationship; and determining at least one first object combination from the candidate object combinations. The first object combination generated in this example may be referred to as an object combination “without a main image”. The first object combination may include the object identifiers of each parent object and the first matching identifier. Category mapping relationships may be preset in the association algorithm. A plurality of categories having a category mapping relationship are strongly associated with each other. For example, shirts, dress pants, and leather shoes may be included in one category mapping relationship, and T-shirts and skirts may be included in another category mapping relationship, but tank tops and cotton-padded shoes may not be maintained in one category mapping relationship.

As another example, on the management page of the target entity, the staff may also manually enter at least one matched object combination based on their experience or sales data of the objects. For example, the management page of the target entity includes an “object matching” function. The staff enters an editing page by selecting “Create new object matching”, and then create a matching combination on the editing page through operations such as uploading a matching main image or adding products. After the matching combination is approved, it may be considered that a first object combination has been created.

For example, a process of manually creating a first object combination without a main image may include the following steps. S11: selecting at least two parent objects from the target entity. S12: setting a matching name and a recommendation text, and optionally setting a matching discount, where if no matching discount is set, no discount is applied by default. S13: clicking “Finish creation” to obtain the first object combination, clicking “Back” to return to modify or reselect parent objects, or clicking “Cancel” to exit the current process of creating the first object combination. The matching name may have a present character limit, for example, 10 characters; and the recommendation text may also have a preset character limit, for example, 40 characters.

For another example, a process of manually creating a first object combination with a main image may include the following steps: S21: uploading a matching image that includes at least two parent objects. S22: selecting a parent object corresponding to the matching image in the target entity. S23: selecting a pointing position of the parent object (selected in S22) in the matching image, and configuring an anchor point name. S24: setting a matching name and a recommendation text, and optionally setting a matching discount, where if no matching discount is set, no discount is applied by default. S25: clicking “Finish creation” to obtain the first object combination, clicking “Back” to return to modify or reselect parent objects, or clicking “Cancel” to exit the current process of creating the first object combination. The matching image may be a 1:1 image, and after uploading, may be previewed in a section (e.g., on the left side) of the creation page.

In the two processes of manually creating the first object combination described above, the matching name may have a preset character limit, for example, 10 characters; and the recommendation text may also have a preset character limit, for example, 40 characters. After the matching name and the recommendation text are set, the matching image may be previewed in a section (e.g., on the left side) of the creation page.

It may be understood that an anchor point refers to a mark that can link to an object detail page of an object. For example, when there is no operation for an anchor point, the anchor point may be displayed, for example, as a dot. When the staff moves the cursor over a preset area where the anchor point is located, relevant information of the object corresponding to the anchor point, such as a product name or price, may be displayed near the anchor point. When the staff clicks the anchor point, the display page may navigate to the object detail page of the object corresponding to the anchor point.

Assuming that the first object combination includes a first parent object and a second parent object in the target entity, then S101 may, for example, include: obtaining, in response to creating the first object combination on the management page of the target entity, relevant information of the first parent object and relevant information of the second parent object. The relevant information of the first parent object may include at least an object identifier of the first parent object, and the relevant information of the second parent object may include at least an object identifier of the second parent object. The object identifier may be, for example, information that can uniquely identify the object, such as a name of the object, a serial number of the object, or an ID of the object.

It should be noted that the first object combination can only be created from parent objects belonging to the same target entity, and parent objects belonging to different entities cannot be matched to create the first object combination.

It should be noted that a maximum limit on the number of first object combinations, for example, 500, may be set for the target entity. In this case, the number of first object combinations created in the target entity cannot exceed 500. If the target entity already includes 500 first object combinations, when creation of a new first object combination is performed on the management page of the target entity, the creation of the new first object combination may fail because the number of first object combinations in the target entity exceeds the maximum limit.

It should be noted that, when the number of parent objects in a listed state in the first object combination is less than 2, the creation of the first object combination may be considered failed, or the created first object combination may be automatically delisted.

It should be noted that, in order to enable the online consumption platform to provide a safer and healthier environment, after the first object combination is created, compliance review may also be performed on content such as images or copy in the first object combination. Upon approval, the following S102 to S103 may be triggered to automatically create an object combination of child objects in a sub-entity of the target entity.

S102: obtaining a target child object corresponding to each of the at least two parent objects from sub-entities of the target entity, where attribute information of the target child object is the same as attribute information of the corresponding parent object.

The sub-entities of the target entity may refer to a plurality of subordinate entities of the target entity. For example, the target entity is the headquarters of a chain enterprise A, and the sub-entity of the target entity is any store belonging to the chain enterprise A. Alternatively, the target entity is any managed unit store a of the chain enterprise A, and the sub-entities of the target entity are a plurality of stores belonging to the managed unit store a of the chain enterprise A.

Objects in a sub-entity are referred to as child objects in the sub-entity. The “parent” and “child” before the object are names defined to distinguish between levels of entities to which the objects belong. Parent objects exist only in entities, and child objects exist only in sub-entities. Parent objects cannot be displayed and sold to consumers, and child objects can be displayed and sold to consumers. For example, if the chain enterprise A serves as the target entity, and the headquarters thereof includes ten different types of milk: milk 1 to milk 10, the milk 1 to milk 10 may be understood as 10 parent objects of the target entity. If the milk 1 to milk 8 are distributed to a store 1 of the chain enterprise A, the store 1 serving as a sub-entity of the target entity, the milk 1 to milk 8 may be understood as 8 child objects of the sub-entity.

As an example, S102 may, for example, include: obtaining, for each parent object in the first object combination, a child object corresponding to the parent object from the sub-entity of the target entity, which is denoted as a target child object. Assuming that the first object combination includes a first parent object and a second parent object, and the target entity includes a sub-entity 1 and a sub-entity 2, then S102 may include: obtaining a child object 11 corresponding to the first parent object and a child object 12 corresponding to the second parent object from the sub-entity 1; and obtaining a child object 21 corresponding to the first parent object and a child object 22 corresponding to the second parent object from the sub-entity 2. If the target entity further includes a sub-entity 3, and a child object 32 in the sub-entity 3 that corresponds to the second parent object is not listed, then S102 may include: obtaining a child object 31 corresponding to the first parent object from the sub-entity 3. The target child objects obtained from the sub-entity 1 include the child object 11 and the child object 12, the target child objects obtained from the sub-entity 2 include the child object 21 and the child object 22, and the target child objects obtained from the sub-entity 3 include only the child object 31.

It can be seen that, the execution of S102 prepares for the implementation of S103 of obtaining the object combination of child objects by inheriting the object combination of parent objects.

S103: displaying, for a first sub-entity including at least two target child objects among the sub-entities of the target entity, a second object combination on a management page of the first sub-entity, where the second object combination includes the at least two target child objects.

The first sub-entity may be considered as any sub-entity of the target entity that satisfies the following condition: at least two target child objects are obtained through S102. In the example of the target entity including the sub-entity 1, the sub-entity 2 and the sub-entity 3, the sub-entity 1 and the sub-entity 2 may both be considered as a first sub-entity, and the sub-entity 3 cannot be considered as a first sub-entity.

As an example, S103 may include the following steps. S1031: determining, based on the number of target child objects in each sub-entity of the target entity obtained in S102, at least one first sub-entity including at least two target child objects. S1032: creating, for each of the at least one first sub-entity, a second object combination from at least two target child objects in the first sub-entity. S1033: displaying the corresponding second object combination on a management page of each of the at least one first sub-entity. In this way, by inheriting the first object combination of parent objects in the target entity, the second object combination of child objects is automatically created in the first sub-entity of the target entity.

It should be noted that, linkage of the object combination of child objects may be triggered by some operations (e.g., delisting, updating, or deletion) on the object combination of parent objects. However, some other operations (e.g., listing) on the object combination of parent objects may not trigger automatic linkage. Therefore, in the present embodiment of the present disclosure, matching identifiers of object combinations of child objects that inherit an object combination of parent objects may differ from each other, and differ from a matching identifier of the object combination of parent objects. For example, a matching identifier of the first object combination in the target entity is 123, a matching identifier of a second object combination 1 in the sub-entity 1 of the target entity that inherits the first object combination may be 456, and a matching identifier of a second object combination 2 in the sub-entity 2 of the target entity that inherits the first object combination may be 789.

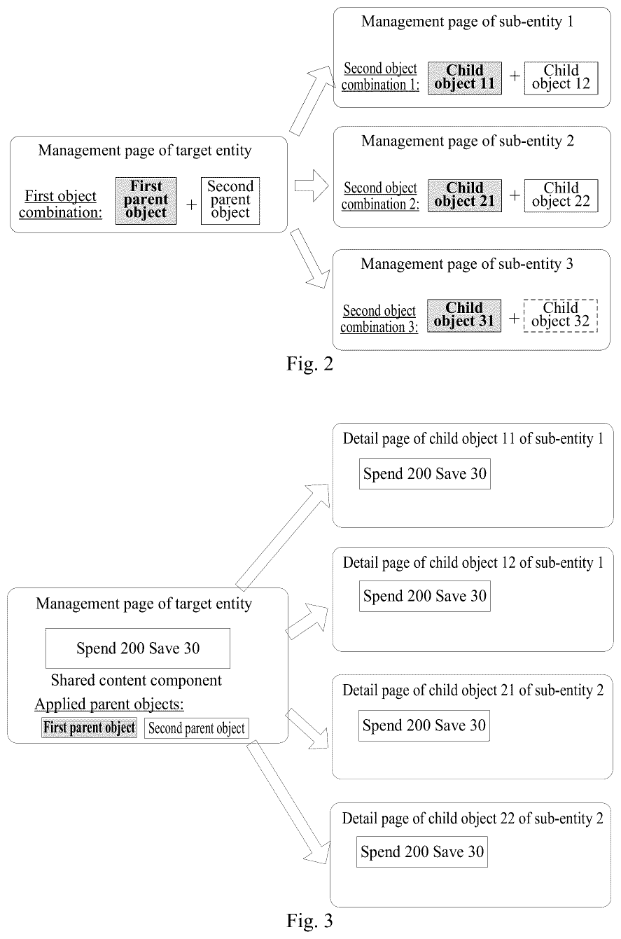

For example, as shown in FIG. 2, assuming that the first object combination created in the target entity includes the first parent object and the second parent object, and the target entity includes the sub-entity 1, the sub-entity 2 and the sub-entity 3, according to the present embodiment of the present disclosure, the second object combination 1 may be displayed on a management page of the sub-entity 1, and the second object combination 1 may include the child object 11 corresponding to the first parent object and the child object 12 corresponding to the second parent object. The second object combination 2 may be displayed on a management page of the sub-entity 2, and the second object combination 2 may include the child object 21 corresponding to the first parent object and the child object 22 corresponding to the second parent object. Since there is only one target child object (i.e., the child object 31), no object combination of child objects inherited from the first object combination is displayed on a management page of the sub-entity 3, where this absence is indicated by a light gray font and dashed lines in FIG. 2.

Through S103, it may be considered that the second object combination is created on the management page of the first sub-entity. The listing manners for the second object combination may include, but are not limited to the following. In Manner 1: manual listing, that is, after S103, the method may further include: listing the second object combination in the first sub-entity in response to performing a listing operation on the second object combination on the management page of the first sub-entity. In Manner 2, implementing the automatic listing of the second object combination through a synchronization operation on the first object combination, that is, after S103, the method may further include: listing the second object combination in the first sub-entity in response to performing the synchronization operation on the first object combination on the management page of the target entity. By listing the second object combination, users can view the second object combination included in the first sub-entity on the online consumption platform, thereby enabling a matched purchase based on the second object combination.

After S103, a state of the second object combination may be linked with some operations on the first object combination. The linked operations may include: an update operation, a delisting operation, or a delete operation.

As an example, for the updating for the first object combination, the method may further include: displaying, in response to updating the first object combination on the management page of the target entity, an updated second object combination on the management page of the first sub-entity, where the updated second object combination corresponds to the updating for the first object combination.

As an example, for the delisting of the first object combination, the method may further include: modifying a first state of the second object combination into a second state on the management page of the first sub-entity in response to performing a first operation on the first object combination on the management page of the target entity. After the second object combination is delisted from the management page of the first sub-entity, users can no longer view the second object combination in the first sub-entity on the online consumption platform. The first operation may refer to an operation of delisting the first object combination, for example, modifying the first state of the first object combination into the second state. An object combination in the second state is an object combination used to be hidden or deleted from a display page of the first sub-entity.

As an example, for the deletion of the first object combination, the method may further include: deleting the second object combination from the management page of the first sub-entity in response to deleting the first object combination from the management page of the target entity. Unlike delisting, if the first object combination is deleted from the management page of the target entity, the first object combination no longer exists on the management page of the target entity after being deleted. However, if the first object combination is delisted from the management page of the target entity, the first object combination may still be displayed on the management page of the target entity after being delisted, except that a state of the first object combination is a delisted state. Similarly, if the second object combination is deleted from the management page of the first sub-entity, the second object combination no longer exists on the management page of the first sub-entity after being deleted. However, if the second object combination is delisted from the management page of the first sub-entity, the second object combination may still be displayed on the management page of the first sub-entity after being delisted, except that a state of the second object combination is a delisted state.

In some implementations, for a second sub-entity of the target entity that includes only one target child object, creation of the second object combination corresponding to the first object combination may be deferred in the second sub-entity. After the second sub-entity includes two or more target child objects, the second object combination corresponding to the first object combination can be created in the second sub-entity through a synchronization operation on the first object combination in the target entity.

As an example, assuming that a third object combination of the target entity may include the first parent object and the second parent object, and the second sub-entity of the target entity includes only a first target child object corresponding to the first parent object, the method may further include: associating, in response to setting a second target child object corresponding to the second parent object in the second sub-entity to the first state and performing the synchronization operation on the third object combination, the third object combination on a management page of the second sub-entity to obtain a fourth object combination, and displaying the fourth object combination on a display page of the second sub-entity, where the fourth object combination includes the first target child object and the second target child object, and a child object in the first state is a child object used to be displayed on the display page of the second sub-entity. The second sub-entity may be, for example, the sub-entity 3 shown in FIG. 2. In the object management process shown in FIG. 2, the child object 32 corresponding to the first parent object in the sub-entity 3 may be considered to be in a delisted state. This example may be understood as follows: after the child object 32 is listed, the synchronization operation may be performed on the first object combination (i.e., the third object combination) on the management page of the target entity to enable the inheritance of the first object combination in the sub-entity 3, such that the sub-entity 3 may include a second object combination 3 (i.e., the fourth object combination). Moreover, based on the synchronization operation, the second object combination 3 may be automatically listed when the first object combination is listed.

It should be noted that, there may only be one active task at the same time. For example, when a task of inheriting the first object combination of the target entity to the first sub-entity is being performed, operations such as editing the first object combination of the target entity cannot be performed. The functions such as creation, synchronization, and updating are mutually exclusive, meaning that a user can only perform an operation on one function of one object combination at a time. Each function belongs to one executable operation of an object, and each function may correspond to a control such as a separate button. After the user clicks a control corresponding to an operation, it is necessary to first determine whether there are other ongoing tasks. If yes, a pop-up or similar prompt appears requesting the user to try again later. The title of the pop-up may be “Operation failed”, the main text of the pop-up may be “An ongoing task prevents this operation from being executed. Please try again later”, and the pop-up has an “OK” button.

If the operation such as creation, updating, or synchronization fails, a “View batch operation records” button may be added to the pop-up, and clicking the button may direct the user to a page corresponding to batch operation records to view details of the failure. On the page corresponding to batch operation records, each row may display details of a batch task in.

In the batch operation records, for batch processing failures of an object combination of parent objects or object combination of child objects, possible operations may include the following: (1) Viewing main matching, including viewing a name of the object combination of parent objects corresponding to the task and/or an ID of the object combination, further including viewing images corresponding to the object combination of parent objects; (2) Viewing operation types, including all executable operations on the object combinations of child objects; (3) Downloading failure details, where a “Download failure details” button appears when the task fails, and clicking the button may enable the user to download relevant information of the failed object combination of child objects. A downloaded spreadsheet may include the following columns: an ID of the object combination of parent objects, an ID of a sub-entity, an ID of a child object, and a failure reason. The downloaded table may include the following row: an ID of a child object. It should be noted that all child objects in an object combination of a sub-entity need to be included in a downloaded spreadsheet of failure records.

For example, a certain object combination of the target entity includes a parent object a, a parent object b and a parent object c, and an ID of the object combination is 123. If the target entity includes a sub-entity 1, a sub-entity 2 and a sub-entity 3, where the sub-entity 1 includes a child object a1, a child object b1 and a child object c1, the sub-entity 2 includes a child object a2 and a child object b2, and the sub-entity 3 includes a child object a3, a child object b3 and a child object c3, with the child object a3 being delisted, then a downloaded table for failure records may be, for example, as shown in Table 1 below.

TABLE 1

| ID of object | ID of sub- | ID of child | |
|---|---|---|---|
| combination | entity | object | Failure reason |
| 123 | 2 | a2 | Some child products |
| | | | do not exist |
| 123 | 2 | b2 | Some child products |
| | | | do not exist |
| 123 | 3 | a3 | Some child products |
| | | | are delisted |
| 123 | 3 | b3 | Some child products |
| | | | are delisted |
| 123 | 3 | c3 | Some child products |
| | | | are delisted |
| 123 | 1 | a1 | System exception |
| 123 | 1 | b1 | System exception |
| 123 | 1 | c1 | System exception |

It can be seen that, through the method, an object combination of parent objects created in a chain entity can be automatically inherited by each sub-entity of the chain entity, and an object combination of child objects corresponding to the object combination of parent objects created by the chain entity can be automatically obtained on a management page of each sub-entity. This eliminates the need for staff to manually configure corresponding object combinations of child objects one by one across numerous sub-entities of a chain enterprise based on the object combination of parent objects, thereby significantly reducing labor, resources, and time costs, improving the efficiency of managing the child objects included in the sub-entities of the chain entity, and enabling more intelligent management of the chain entity in the instant retail scenario.

In some possible implementations, some shared content of the target entity needs to be configured into a plurality of sub-entities of the target entity. In this case, the method may further include a process of batch display (or referred to as delivery) of shared content components. As an example, the method may further include the following steps. S201: obtaining, in response to creating a shared content component to be displayed on the management page of the target entity and selecting a set of parent objects to be displayed, a set of child objects corresponding to the set of parent objects from the sub-entities of the target entity, where the set of parent objects includes at least one parent object, and child objects included in the set of child objects are in a one-to-one correspondence with parent objects included in the set of parent objects. S202: displaying the shared content component in each child object included in the set of child objects for each of the sub-entities of the target entity.

The shared content component may refer to a component such as an image or text that can be reused across detail pages of a plurality of objects. For example, it may be an image corresponding to usage instructions, preparation instructions, event descriptions, etc. that need to be displayed on a detail page of an object. Displaying the shared content component in the child object in S202 may refer to adding the shared content component to a preset position on a detail page of the child object.

A functional module corresponding to this implementation can batch apply shared content components edited for the parent object in the target entity to detail pages of the child objects corresponding to the parent object in the sub-entities of the target entity. It should be noted that, if the sub-entity has permission, it can customize a display time of the shared content component on its own detail page.

The display of the shared content component in this embodiment of the present disclosure may include timed display and real-time display.

An implementation process for real-time display may include: (1) creating a shared content component to be displayed on the management page of the target entity; (2) selecting a parent object to be displayed; (3) submitting; (4) reviewing; and (5) upon approval, activating the shared content component on detail pages of child objects in the sub-entities of the target entity that correspond to the parent object to be displayed.

An implementation process for timed display may include: (1) creating a shared content component to be displayed on the management page of the target entity; (2) configuring a display time of the shared content component; (3) selecting a parent object to be displayed; (4) submitting; (5) reviewing; and (6) upon approval, based on the configured display time, activating the shared content component on detail pages of child objects in the sub-entities of the target entity that correspond to the parent object to be displayed. It should be noted that, during the period when the shared content component is active on the detail pages of the child objects, if the shared content component is to be deleted, a task of displaying the shared content component may be stopped first, and then the shared content component may be deleted. In this case, S202 may, for example, include: displaying, in response to the shared content component being configured with a display time, the shared content component in each child object included in the set of child objects for each of the sub-entities of the target entity based on the display time.

For the process of creating the shared content component to be displayed, on the management page of the target entity, a function of creating a shared content component may be selected. Upon entering a page of the function, first, a timed display manner or real-time display manner may be selected; next, the shared content component to be displayed is set; then after the setting is completed, the page navigate to a decoration module, to edit the display manner of the shared content component on the detail page, for example, set a name of the shared content component and select a position of the shared content component on the detail page. A character limit for the name of the shared content component may be preset, for example, 20 characters. The position of the shared content component on the detail page may be set to Top, Bottom, or Other. “Top” may refer to the very top of the current detail page, and “Bottom” may refer to the very bottom of the current detail page. “Other” may refer: When a plurality of shared content components are displayed on one detail page at the same time, the newly displayed content indicates a position of the newly displayed shared content component among other shared content components, for example, Other-Top may refer to placing the newly displayed shared content component at the top of the detail page and moving the previously displayed shared content components downward. It should be noted that, after being created, the shared content component to be displayed may be previewed in a section (e.g., on the left side) of the creation page.

It should be noted that, in the case where the target entity is a chain enterprise, the headquarters and the managed unit stores are supported to set a shared content component for a parent product, and child products may automatically inherit the shared content component. Stores typically cannot set shared content components separately for their own child products.

It should be noted that, when a shared content component is edited for a parent product, child products corresponding to the parent product automatically inherit the modified shared content component. It is not allowed to select a part of sub-entities displaying the shared content component to activate the modified shared content component. Instead, it is required to activate the modified shared content component in all sub-entities displaying the shared content component, to ensure that information about the shared content component is consistent between the child products and the parent product. In the case where the information about the shared content component is inconsistent between the parent product and the child products and some detail fields on the detail pages may support differentiated setting, a part of the sub-entities may be selected to activate the modified shared content component, and the shared content component before modification may be activated in the other sub-entities.

For the real-time display function, all the detail pages may be set directly, and after setting, the shared content component may be modified for both the parent product and the child products during editing of the detail pages of the objects. It should be noted that, editing of the shared content component for the child products requires the child products and the sub-entity to which the child products belong to be on a whitelist. The whitelist may include child products or sub-entities supporting differentiated editing of product details.

For the real-time display function, after the detail pages are set, neither the parent product nor the child products can have the shared content component edited. If the shared content component needs to be modified, it is required to end the task of displaying the shared content component first.

It should be noted that, there may be a plurality of timed-display shared content components displayed at the top and bottom at the same time, and the plurality of shared content components may be displayed stacked upward or downward.

For selection of the parent object to be displayed, in one case, if the sub-entity cannot operate the shared content component, the parent objects to be displayed may be selected directly, to display the parent objects on the child objects corresponding to all the sub-entities. The selection of the parent object to be displayed may support filtering based on an ID of the parent object, a code of the target entity, a name of the parent object, a category name or a status of the parent object, and the selection of the parent object to be displayed may be achieved by checking. In another case, if the sub-entity can operate the shared content component, a sub-entity to be displayed may be selected after the parent object to be displayed is selected. Alternatively, a sub-entity to be displayed and a child object to be displayed in the sub-entity may be selected, such that the shared content component may be activated on the selected child object, and the shared content component is not displayed on an unselected child object. Since sub-entities distributed by a plurality of parent objects may be different, if a selected sub-entity does not have a corresponding child object for a parent object, no batch display processing is performed.

A review link is entered after the display is completed, and the display may be continued, or display records may be viewed. In the display records, the real-time display and the timed display may be displayed as two categories. In a display task list under each category, the displayed shared content component (e.g., an image of event descriptions), the name of the shared content component, the number of associated objects, a display status, operations, etc. may be displayed. The display status may include: display completed or display failed. A reason for display failure may be either a system reason or a review failure. The reason for display failure may be displayed when the cursor hovers over the “Display failed” area. The operations may include: ending the display, deleting the display, or viewing details, where only the shared content component with the display ended can be deleted. Through the operation of clicking to view details, a side-sliding pop-up or another form may be used to display details of child objects in the current display, including, but not limited to: an ID, price, sales, a display status, etc. of the child object. If there is a display task of displaying a part of the sub-entities, the number of the sub-entities may also be displayed. Therefore, the display operation may further include: viewing display details of the sub-entities. For display details of the sub-entity, details of the sub-entity displayed by the display task under the parent object may be displayed, which may include a name of the sub-entity, an ID of the sub-entity, and a display status, to support filtering based on the name of the sub-entity and/or ID of the sub-entity.

For example, as shown in FIG. 3, assuming that an event description image “Spend 200 Save 30” is created on the management page of the target entity and applied to the first parent object and the second parent object of the target entity, the target entity includes a sub-entity 1 and a sub-entity 2, a child object 11 in the sub-entity 1 corresponds to the first parent object, a child object 12 in the sub-entity 1 corresponds to the second parent object, a child object 21 in the sub-entity 2 corresponds to the first parent object, and a child object 22 in the sub-entity 2 corresponds to the second parent object, after real-time display of the event description image is achieved through the batch display function in this embodiment of the present disclosure, detail pages of the child object 11, the child object 12, the child object 21 and the child object 22 all include the event description image “Spend 200 Save 30”.

It can be seen that, in the present embodiment of the present disclosure, the shared content component created in a chain entity can be automatically inherited by a child object of each sub-entity of the chain entity, and a shared content component created by the chain entity can be automatically obtained on a detail page of each child object. This eliminates the need for staff to repeatedly configure shared content to be configured one by one across all the child objects, thereby significantly reducing labor, resources, and time costs, improving the efficiency of managing the child objects included in the sub-entities of the chain entity, and enabling more intelligent management of the chain entity in the instant retail scenario.

In some possible implementations, the target entity also needs to batch apply material images uploaded by some parent objects without material images to corresponding child objects in each sub-entity, such that each child object can be conveniently configured with the material image. The child objects with the material images may provide a better viewing experience for users, thereby improving the consumer experience of users for the child objects. Therefore, the method may further include a process of quickly uploading material images and batch applying them to the child objects. As an example, the method may further include the following steps. S301: obtaining, in response to an upload operation of a material image for a third parent object on a material image management tool of the target entity, a first material image of the third parent object, where the material image management tool is used to display a material image upload status of each parent object in the target entity. S302: applying, in response to the first material image being approved, the first material image in a child object corresponding to the third parent object for each of the sub-entities of the target entity.

The material image may be any type of an image displayed on a detail page of an object, for example, a white background image of the object. The following description is made with an example of the material image being a white background image, and the white background image below may be replaced with any other material image.

Although a function entry for uploading a white background image has been opened on a publishing and/or editing page of an object to support staff to upload a white background image for a single child object, it is inconvenient for staff of the headquarters or managed unit stores of a chain enterprise to view the white background image upload status of a plurality of parent objects. In the present embodiment of the present disclosure, a functional module for viewing the white background image status of each parent object is further opened on the management page of the target entity, and an entry for uploading a white background image is added to an operation option of a parent object without an uploaded white background image, to help the staff to understand the white background image status of all the parent objects, enabling timely identification and completion of omissions, and online preview and editing, to upload a white background image for the parent object without a white background image.

Only the target entity has permission to the function provided in the embodiment of the present disclosure, that is, only the headquarters or managed unit stores of the chain enterprise can use the function, while the stores cannot use it. The child products in the stores automatically inherit the white background image of the approved parent product. The white background image has an independent review status and can be appealed separately. A separate entry to the function may be designed on the management page of the target entity. Alternatively, a function entry for uploading a white background image on a publishing and/or editing page for a current object may be modified to enter the function.

When staff clicks a white background image management function on the management page of the target entity, all the parent objects of target entity and the white background image status corresponding to the parent object may be displayed. Displayed information may, for example, include: a main image of the parent object, a name of the parent object, a category to which the parent object belongs, an ID of the parent object, a status of the parent object (e.g., on sale, delisted, etc.), a white background image of the parent object, or a review status. For a parent object with a white background image, the displayed information includes the white background image of the parent object, and for a parent object without a white background image, an upload entry for the white background image of the parent object is displayed.

A display area corresponding to the white background image management function may be classified for display and filtering based on a status of a white background image. The status of the white background image may include: all, to be uploaded, published, and rejected. The filtering of the parent object in the display area may be implemented based on the ID of the parent object, the name of the parent object, or the status of the parent object.

The review status in the displayed information may refer to a review status of the uploaded white background image, which may specifically include: under review, approved, rejected by automated review, or rejected by manual review.

For a parent object without a white background image, an upload entry for the white background image of the parent object is displayed. Copy of the upload entry may be “Upload image”, and when the “Upload image” area is clicked, uploading a white background image may be supported in the following three methods. Method 1 is Auto-fill. When the main image of the parent object or any image on the detail page includes a white background image or an image from which a white background image can be cut out, the upload method may include an “Auto-fill” option. After clicking “Auto-fill”, the white background image may be automatically obtained. Method 2 is Local upload. After clicking “Local upload”, an upload tool may be triggered to open a local folder, from which the white background image can be selected. Method 3 is Select from gallery. An existing image may be selected from a material image library of a working website for the target entity on the online consumption platform, to obtain the white background image.

After being uploaded, the white background image is directly submitted for review, and upon approval, the white background image is determined as the white background image of the parent object.

For the parent object with a white background image, when the cursor hovers over the white background image, the executable operations include, but are not limited to, the following. Operation 1: Preview, i.e., view an enlarged image of the white background image. Operation 2: Crop, i.e., trigger an image editor to crop the white background image, then upload and submit it for review, and upon approval, apply the cropped white background image. Operation 3: Delete, i.e., delete the white background image.

A white background image management list may enter a separate material review queue, to review only the compliance of the image, without reviewing other information of the parent object, making the review process clear and concise and more efficient than the review process for other products. The review of the white background image may be classified into manual review and automated review. In the case of a rejected white background image, an appeal is not allowed if the rejection is made after manual review; or if the rejection is made after automated review, an appeal is allowed to provide a reason, and then the white background image is sent to a manual review queue. It should be noted that, in this embodiment of the present disclosure, functions of batch appeal and batch deletion for rejected white background images are also supported to improve the efficiency of uploading and batch application of white background images.

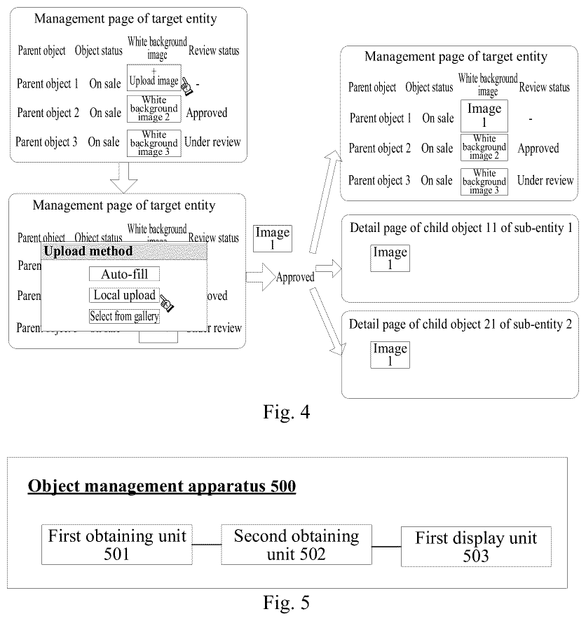

For example, as shown in FIG. 4, assuming that on the management page of the target entity, the target entity includes a sub-entity 1 and a sub-entity 2, the sub-entity 1 includes a child object 11 corresponding to the parent object 1, and the sub-entity 2 includes a child object 21 corresponding to the parent object 1, for the parent object 1 including no white background image, by clicking “Upload image” and selecting “Local upload”, an image 1 may be selected from a local image library to upload as a white background image of the parent object 1. Next, the image 1 is reviewed. After approval, on the management page of the target entity, the image 1 is displayed in the white background image section in the parent object 1. The child object 11 and the child object 21 each have a white background image, which is the image 1.

It can be seen that, in the embodiment of the present disclosure, the chain entity may display a material image status of each parent object, to help the staff to understand a parent object without a material image or with an improper material image. For a parent object without an uploaded material image, the material image of the parent object can be uploaded on the management page of the chain entity, where the material image can be automatically inherited by the child object in each sub-entity of the chain entity, and the detail page of each child object can automatically include the material image. This eliminates the need for staff to repeatedly upload material images one by one for the child objects that require configuration of a material image, thereby significantly reducing labor, resources, and time costs, improving the efficiency of managing the child objects included in the sub-entities of the chain entity, and enabling more intelligent management of the chain entity in the instant retail scenario.

Accordingly, an embodiment of the present disclosure further provides an object management apparatus 500, as shown in FIG. 5. The apparatus 500 may include a first obtaining unit 501, a second obtaining unit 502 and a first display unit 503.

The first obtaining unit 501 is configured to obtain, in response to creating a first object combination on a management page of a target entity, at least two parent objects included in the first object combination, where the at least two parent objects belong to the target entity.

The second obtaining unit 502 is configured to obtain a target child object corresponding to each of the at least two parent objects from sub-entities of the target entity, where attribute information of the target child object is the same as that of the corresponding parent object.

The first display unit 503 is configured to display, for a first sub-entity including at least two target child objects among the sub-entities of the target entity, a second object combination on a management page of the first sub-entity, where the second object combination includes the at least two target child objects.

In a possible implementation, a third object combination of the target entity includes a first parent object and a second parent object, a second sub-entity of the target entity includes only a first target child object corresponding to the first parent object, and the apparatus 500 further includes an association display unit.

The association display unit is configured to: associate, in response to setting a second target child object corresponding to the second parent object in the second sub-entity to a first state and performing a synchronization operation on the third object combination, the third object combination on a management page of the second sub-entity to obtain a fourth object combination, and display the fourth object combination on a display page of the second sub-entity, where the fourth object combination includes the first target child object and the second target child object, and a child object in the first state is a child object used to be displayed on the display page of the second sub-entity.

In a possible implementation, the apparatus 500 further includes an update unit and a deletion unit.

The update unit is configured to: display, in response to updating the first object combination on the management page of the target entity, an updated second object combination on the management page of the first sub-entity, where the updated second object combination corresponds to the updating for the first object combination; and modify the first state of the second object combination into a second state on the management page of the first sub-entity in response to performing a first operation on the first object combination on the management page of the target entity, where an object combination in the second state is an object combination used to be hidden or deleted from a display page of the first sub-entity.

The deletion unit is configured to delete the second object combination from the management page of the first sub-entity in response to deleting the first object combination from the management page of the target entity.

In a possible implementation, the apparatus 500 further includes: a second display unit.

The second display unit is configured to display the second object combination on a display page of the first sub-entity in response to performing a synchronization operation on the first object combination on the management page of the target entity.

Or, the second display unit is configured to display the second object combination on a display page of the first sub-entity in response to performing a second operation on the second object combination on the management page of the first sub-entity.

In a possible implementation, the apparatus 500 further includes: a third obtaining unit and a third display unit.

The third obtaining unit is configured to: obtain, in response to creating a shared content component to be displayed on the management page of the target entity and selecting a set of parent objects to be displayed, a set of child objects corresponding to the set of parent objects from the sub-entities of the target entity, where the set of parent objects includes at least one parent object, and the child objects included in the set of child objects are in a one-to-one correspondence with the parent objects included in the set of parent objects.

The third display unit is configured to display the shared content component in each child object included in the set of child objects for each of the sub-entities of the target entity.

In a possible implementation, the third display unit is specifically configured to:
display, in response to the shared content component being configured with a display time, the shared content component in each child object included in the set of child objects for each of the sub-entities of the target entity based on the display time.

In a possible implementation, the apparatus 500 further includes: a fourth obtaining unit and a fourth display unit.

The fourth obtaining unit is configured to obtain, in response to an upload operation of a material image for a third parent object on a material image management tool of the target entity, a first material image of the third parent object, where the material image management tool is used to display a material image upload status of each parent object in the target entity.

The fourth display unit is configured to apply, in response to the first material image being approved, the first material image in a child object corresponding to the third parent object for each of the sub-entities of the target entity.

It should be noted that, for a specific implementation of the apparatus 500 and an achieved technical effect, reference may be made to the relevant description of the method shown in FIG. 1.

In addition, an embodiment of the present disclosure further provides an electronic device. The device includes a processor and a memory, where the memory is configured to store instructions or a computer program; and the processor is configured to execute the instructions or computer program in the memory, to cause the electronic device to perform any implementation of the method according to the embodiments of the present disclosure.

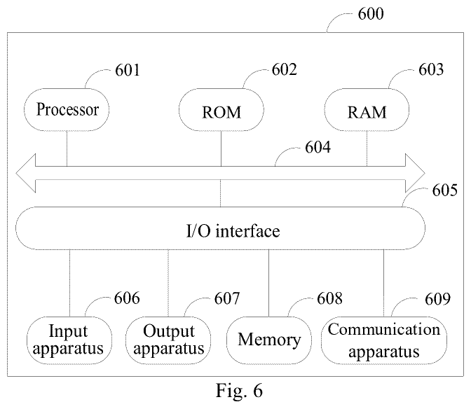

Reference is made to FIG. 6, which is a schematic structural diagram of an electronic device 600 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (e.g., a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processor (for example, a central processing unit or a graphics processing unit) 601 that may perform a variety of appropriate actions and processing in accordance with a program stored in a read-only memory (ROM) 602 or a program loaded from a memory 608 into a random-access memory (RAM) 603. The RAM 603 further stores various programs and data required for operations of the electronic device 600. The processor 601, the ROM 602, and the RAM 603 are connected to one another through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the memory 608 including, for example, a magnetic tape and a hard disk drive; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 609, installed from the memory 608, or installed from the ROM 602. When the computer program is executed by the processor 601, the above-mentioned functions defined in the method of the embodiments of the present disclosure are performed.

The electronic device according to this embodiment of the present disclosure and the method according to the above-mentioned embodiments belong to the same inventive concept. For the technical details not exhaustively described in this embodiment, reference may be made to the above-mentioned embodiments, and this embodiment and the above-mentioned embodiments have the same beneficial effects.

An embodiment of the present disclosure further provides a computer-readable medium storing instructions or a computer program that, when run on a device, causes the device to perform any implementation of the method according to the embodiments of the present disclosure.

It should be noted that the above-mentioned computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk drive, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, a client or a server may perform communication by using any currently known or future-developed network protocol such as a hypertext transfer protocol (HTTP), and may interconnect with digital data communication (e.g., a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above-mentioned computer-readable medium may be included in the above-mentioned electronic device. Alternatively, the computer-readable medium may exist independently, without being assembled into the electronic device.

The above computer-readable medium carries one or more programs that, when executed by the electronic device, enable the electronic device to perform the above-mentioned method.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of the unit/module does not constitute a limitation on the unit itself under certain circumstances.

The functions described herein above may be performed at least partially by one or more hardware logic components. For example, without limitation, example types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk drive, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

It should be noted that the various embodiments in this specification are described in a progressive manner, and each embodiment focuses on differences from other embodiments. The same or similar parts between the various embodiments may be referenced to each other. For the system or apparatus disclosed in this embodiment, since it corresponds to the method disclosed in the embodiments, the description is relatively simple, and for the related parts, reference may be made to the description of the method.

It should be understood that, in the present disclosure, “at least one” means one or more, and “a plurality of” means two or more. The term “and/or” is used to describe an association relationship between associated objects, and indicates that three relationships may exist, for example, A and/or B may indicate that: only A exists, only B exists, and both A and B exist, where A or B may be singular or plural. The character “/” generally indicates an “or” relationship between the associated objects. “At least one of the following” or similar expressions refers to any combination of these items, including any combination of single items or plural items. For example, at least one of a, b, or c may indicate: a, b, c, “a and b”, “a and c”, “b and c”, or “a and b and c”, where a, b, or c may be singular or plural.

It should also be noted that, herein, relative terms such as “first” and “second” are only used to distinguish one entity or operation from another entity or operation, and do not necessarily require or imply that such an actual relationship or order exists between these entities or operations. Moreover, the terms “include”, “including”, “comprise” and “comprising”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including/comprising a/an . . . ” does not exclude another identical element in a process, method, article, or device that includes the element.

The steps of the method or algorithm described in conjunction with the embodiments disclosed herein may be implemented directly in hardware, in a software module executed by a processor, or in a combination of the two. The software module may be disposed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

It should be noted that in the embodiments of the present disclosure, sensitive user information is not involved, and all user-related information is acquired, used, and determined upon authorization of the user. In one example, prior to the acquisition of the user-related information, prompt information related to the acquisition of data use authorization is displayed in a corresponding interface, where the prompt information is used to inform the user of the type, range of use, use scenarios, etc., of personal information involved in the present disclosure in an appropriate manner in accordance with relevant laws and regulations, so that the user determines whether to agree to the authorization based on the prompt information. It can be understood that the above-mentioned process of notifying and obtaining the authorization of the user is only illustrative and does not constitute a limitation on the implementations of the present disclosure, and other manners that satisfy the relevant laws and regulations may also be applied in the implementations of the present disclosure.

With respect to the above-mentioned description of the disclosed embodiments, those skilled in the art could implement or use the present disclosure. Various modifications to these embodiments are apparent to those skilled in the art, and the general principle defined herein may be practiced in other embodiments without departing from the spirit or scope of the present disclosure. Therefore, the present disclosure will not be limited to the embodiments shown herein, but extends to the widest scope that complies with the principles and novelty disclosed in this specification.

1. An object management method, comprising:
obtaining, in response to creating a first object combination on a management page of a target entity, at least two parent objects comprised in the first object combination, wherein the at least two parent objects belong to the target entity;
obtaining a target child object corresponding to each of the at least two parent objects from sub-entities of the target entity, wherein attribute information of the target child object is the same as attribute information of the corresponding parent object; and
displaying, for a first sub-entity comprising at least two target child objects among the sub-entities of the target entity, a second object combination on a management page of the first sub-entity, wherein the second object combination comprises the at least two target child objects.

2. The method according to claim 1, wherein a third object combination of the target entity comprises a first parent object and a second parent object, a second sub-entity of the target entity comprises only a first target child object corresponding to the first parent object, and the method further comprises:
associating, in response to setting a second target child object corresponding to the second parent object in the second sub-entity to a first state and performing a synchronization operation on the third object combination, the third object combination on a management page of the second sub-entity to obtain a fourth object combination, and displaying the fourth object combination on a display page of the second sub-entity, wherein the fourth object combination comprises the first target child object and the second target child object, and a child object in the first state is a child object used to be displayed on the display page of the second sub-entity.

3. The method according to claim 1, further comprising:
displaying, in response to updating the first object combination on the management page of the target entity, an updated second object combination on the management page of the first sub-entity, wherein the updated second object combination corresponds to the updating for the first object combination;
modifying the first state of the second object combination into a second state on the management page of the first sub-entity in response to performing a first operation on the first object combination on the management page of the target entity, wherein an object combination in the second state is an object combination used to be hidden or deleted from a display page of the first sub-entity; and
deleting the second object combination from the management page of the first sub-entity in response to deleting the first object combination from the management page of the target entity.

4. The method according to claim 1, further comprising:
displaying the second object combination on a display page of the first sub-entity in response to performing a synchronization operation on the first object combination on the management page of the target entity;
or
displaying the second object combination on a display page of the first sub-entity in response to performing a second operation on the second object combination on the management page of the first sub-entity.

5. The method according to claim 1, further comprising:
obtaining, in response to creating a shared content component to be displayed on the management page of the target entity and selecting a set of parent objects to be displayed, a set of child objects corresponding to the set of parent objects from the sub-entities of the target entity, wherein the set of parent objects comprises at least one parent object, and child objects comprised in the set of child objects are in a one-to-one correspondence with parent objects comprised in the set of parent objects; and
displaying the shared content component in each child object comprised in the set of child objects for each of the sub-entities of the target entity.

6. The method according to claim 5, wherein the displaying the shared content component in each child object comprised in the set of child objects for each of the sub-entities of the target entity, comprises:
displaying, in response to the shared content component being configured with a display time, the shared content component in each child object comprised in the set of child objects for each of the sub-entities of the target entity based on the display time.

7. The method according to claim 1, further comprising:
obtaining, in response to an upload operation of a material image for a third parent object on a material image management tool of the target entity, a first material image of the third parent object, wherein the material image management tool is used to display a material image upload status of each parent object in the target entity; and
applying, in response to the first material image being approved, the first material image in a child object corresponding to the third parent object for each of the sub-entities of the target entity.

8. (canceled)

9. An electronic device, comprising: at least one processor and at least one memory,
wherein the at least one memory is configured to store instructions or a program; and
the at least one processor is configured to execute the instructions or the program stored in the at least one memory, to cause the electronic device to perform an object management method, and the method comprises:
obtaining, in response to creating a first object combination on a management page of a target entity, at least two parent objects comprised in the first object combination, wherein the at least two parent objects belong to the target entity;
obtaining a target child object corresponding to each of the at least two parent objects from sub-entities of the target entity, wherein attribute information of the target child object is the same as attribute information of the corresponding parent object; and
displaying, for a first sub-entity comprising at least two target child objects among the sub-entities of the target entity, a second object combination on a management page of the first sub-entity, wherein the second object combination comprises the at least two target child objects.

10. A computer-readable storage medium, wherein the computer-readable storage medium stores instructions or a program, when the instructions or the program is run on a processor, the processor is caused to perform an object management method, and the method comprises:
obtaining, in response to creating a first object combination on a management page of a target entity, at least two parent objects comprised in the first object combination, wherein the at least two parent objects belong to the target entity;
obtaining a target child object corresponding to each of the at least two parent objects from sub-entities of the target entity, wherein attribute information of the target child object is the same as attribute information of the corresponding parent object; and
displaying, for a first sub-entity comprising at least two target child objects among the sub-entities of the target entity, a second object combination on a management page of the first sub-entity, wherein the second object combination comprises the at least two target child objects.

11. The electronic device according to claim 9, wherein a third object combination of the target entity comprises a first parent object and a second parent object, a second sub-entity of the target entity comprises only a first target child object corresponding to the first parent object, and the method further comprises:
associating, in response to setting a second target child object corresponding to the second parent object in the second sub-entity to a first state and performing a synchronization operation on the third object combination, the third object combination on a management page of the second sub-entity to obtain a fourth object combination, and displaying the fourth object combination on a display page of the second sub-entity, wherein the fourth object combination comprises the first target child object and the second target child object, and a child object in the first state is a child object used to be displayed on the display page of the second sub-entity.

12. The electronic device according to claim 9, wherein the method further comprises:
displaying, in response to updating the first object combination on the management page of the target entity, an updated second object combination on the management page of the first sub-entity, wherein the updated second object combination corresponds to the updating for the first object combination;
modifying the first state of the second object combination into a second state on the management page of the first sub-entity in response to performing a first operation on the first object combination on the management page of the target entity, wherein an object combination in the second state is an object combination used to be hidden or deleted from a display page of the first sub-entity; and
deleting the second object combination from the management page of the first sub-entity in response to deleting the first object combination from the management page of the target entity.

13. The electronic device according to claim 9, wherein the method further comprises:
displaying the second object combination on a display page of the first sub-entity in response to performing a synchronization operation on the first object combination on the management page of the target entity;
or
displaying the second object combination on a display page of the first sub-entity in response to performing a second operation on the second object combination on the management page of the first sub-entity.

14. The electronic device according to claim 9, wherein the method further comprises:
obtaining, in response to creating a shared content component to be displayed on the management page of the target entity and selecting a set of parent objects to be displayed, a set of child objects corresponding to the set of parent objects from the sub-entities of the target entity, wherein the set of parent objects comprises at least one parent object, and child objects comprised in the set of child objects are in a one-to-one correspondence with parent objects comprised in the set of parent objects; and
displaying the shared content component in each child object comprised in the set of child objects for each of the sub-entities of the target entity.

15. The electronic device according to claim 14, wherein the displaying the shared content component in each child object comprised in the set of child objects for each of the sub-entities of the target entity, comprises:
displaying, in response to the shared content component being configured with a display time, the shared content component in each child object comprised in the set of child objects for each of the sub-entities of the target entity based on the display time.

16. The electronic device according to claim 9, wherein the method further comprises:
obtaining, in response to an upload operation of a material image for a third parent object on a material image management tool of the target entity, a first material image of the third parent object, wherein the material image management tool is used to display a material image upload status of each parent object in the target entity; and
applying, in response to the first material image being approved, the first material image in a child object corresponding to the third parent object for each of the sub-entities of the target entity.

17. The computer-readable storage medium according to claim 10, wherein a third object combination of the target entity comprises a first parent object and a second parent object, a second sub-entity of the target entity comprises only a first target child object corresponding to the first parent object, and the method further comprises:
associating, in response to setting a second target child object corresponding to the second parent object in the second sub-entity to a first state and performing a synchronization operation on the third object combination, the third object combination on a management page of the second sub-entity to obtain a fourth object combination, and displaying the fourth object combination on a display page of the second sub-entity, wherein the fourth object combination comprises the first target child object and the second target child object, and a child object in the first state is a child object used to be displayed on the display page of the second sub-entity.

18. The computer-readable storage medium according to claim 10, wherein the method further comprises:
displaying, in response to updating the first object combination on the management page of the target entity, an updated second object combination on the management page of the first sub-entity, wherein the updated second object combination corresponds to the updating for the first object combination;
modifying the first state of the second object combination into a second state on the management page of the first sub-entity in response to performing a first operation on the first object combination on the management page of the target entity, wherein an object combination in the second state is an object combination used to be hidden or deleted from a display page of the first sub-entity; and
deleting the second object combination from the management page of the first sub-entity in response to deleting the first object combination from the management page of the target entity.

19. The computer-readable storage medium according to claim 10, wherein the method further comprises:
displaying the second object combination on a display page of the first sub-entity in response to performing a synchronization operation on the first object combination on the management page of the target entity;
or
displaying the second object combination on a display page of the first sub-entity in response to performing a second operation on the second object combination on the management page of the first sub-entity.

20. The computer-readable storage medium according to claim 10, wherein the method further comprises:
obtaining, in response to creating a shared content component to be displayed on the management page of the target entity and selecting a set of parent objects to be displayed, a set of child objects corresponding to the set of parent objects from the sub-entities of the target entity, wherein the set of parent objects comprises at least one parent object, and child objects comprised in the set of child objects are in a one-to-one correspondence with parent objects comprised in the set of parent objects; and
displaying the shared content component in each child object comprised in the set of child objects for each of the sub-entities of the target entity.

21. The computer-readable storage medium according to claim 20, wherein the displaying the shared content component in each child object comprised in the set of child objects for each of the sub-entities of the target entity, comprises:
displaying, in response to the shared content component being configured with a display time, the shared content component in each child object comprised in the set of child objects for each of the sub-entities of the target entity based on the display time.
